(19) United States
(12) Patent Application Publication
(10) Pub. No.: US 2017/0136658 A1
(43) Pub. Date: May 18, 2017

(54) METHOD FOR RECYCLING CARPET

(71) Applicant: Paspek Consulting LLC, Broadview Heights, OH (US)

(72) Inventors: Steven Carl Paspek, Broadview Heights, OH (US); Joseph Edwards Bork, Westlake, OH (US); Alan Fredrick Schroeder, Cleveland, OH (US)

(21) Appl. No.: 15/350,340

(22) Filed: Nov. 14, 2016

Related U.S. Application Data
(60) Provisional application No. 62/255,369, filed on Nov. 13, 2015.
(60) Provisional application No. 62/325,017, filed on Apr. 20, 2016.

(51) Int. Cl. B29B 17/02

(52) U.S. Cl. CPC B29B 17/02; B29B 2017/001

(57) ABSTRACT

A method for recovering face fiber materials and a backing material from a carpet is provided. The carpet includes the face fiber materials, the backing material, and an adhesive. The method includes applying a first mechanical force to the carpet to break a bond between the adhesive and the face fiber materials. The method includes separating at least 25% of the adhesive from the face fiber materials to form a blend of the face fiber material and the backing material. The method includes heating the blend of the face fiber material and the backing material to a temperature sufficient to melt the backing material and convert the backing material into backing droplets, the temperature less than a melting point of the face fiber materials. The method includes cooling the face fiber materials to cause the backing droplets to solidify into granules.

### CROSS-REFERENCE TO RELATED APPLICATIONS

This application claims the benefit of U.S. Provisional Application No. 62/255,369, titled “Method for Recycling Carpet” and filed on Nov. 13, 2015, the entire disclosure of which is hereby incorporated by reference. This application further claims the benefit of U.S. Provisional Application No. 62/325,017, titled “Processes for Recycling Carpet and Products of Such Processes” and filed on Apr. 20, 2016, the entire disclosure of which is hereby incorporated by reference.

### FIELD

The present application relates to carpeting and, more particularly, to a method for recycling carpet.

### BACKGROUND

Carpet suitable as feedstock may be composed of three distinct materials: 1) the face fiber or pile, made of Nylon 6, Nylon 66, polyethylene terephthalate (PET), or other polyesters such as polytrimethylene terephthalate (PTT); 2) the backing, made of polypropylene; and 3) the adhesive, often a blend of an organic component and an optional inorganic component. The organic component is often a styrene butadiene rubber (SBR) or ethylene vinyl acetate (EVA) latex. It can also be a urethane, foamed elastomer, vinyl compound, or a compound containing natural or synthetic rubber. The inorganic filler is often calcium carbonate or limestone mixed into the adhesive to provide weight to the final carpet. Thousands of tons of post-consumer and post-industrial carpet are sent to landfills each year. These carpets can be difficult to recycle, being mixtures of various plastics, adhesives, inorganic fillers, and fibers. Many high-end uses of recycled carpet components require separating the different polymers, removing dirt and other contaminants, and removing the adhesives and other fillers. By design, carpeting is difficult to deconstruct. Carpeting may be built to survive decades of wear without having the face fiber pull free from the backing material, and without the adhesive failing.

A valuable portion of the carpet is typically the “face fiber” material, also sometimes described as “pile,” which is often a polyester or a nylon, and typically makes up from about 35 to about 65 wt. % of the carpet. Carpet to be recycled is often sorted based on its face fiber composition, with nylon carpet currently being more valuable due to the higher demand for recycled nylon.

One conventional method for recovering the face fiber material typically involves shearing, a method for removing face fiber material analogous to shearing a sheep to remove its fleece. In such methods, the balance is typically discarded. An advantage of this method is that most of the non-face fiber portion of the carpet is separated from the face fiber. A disadvantage of the method is that shearing is labor intensive. Pieces of carpet must be unrolled, cut into appropriately-sized pieces, and manually fed one-by-one into a shearing unit. The carpet must be fed into the shearer in the proper orientation, with the face fiber oriented toward the shearing blades, making the sheared fiber susceptible to contamination with the backing material. A further disadvantage of this method is that the yield of face fiber is low—typically only 25% to 50% of the face fiber is recovered.

In shearing, the cutting depth must be carefully adjusted to maximize face fiber recovery while minimizing cutting into the backing material. Unfortunately, carpet thicknesses vary. Deep cuts risk contaminating the sheared fiber, while shallow cuts result in yield losses. Cutter wear in such applications is significant and costly.

Another conventional method of carpet recycling is whole carpet shredding. The entire carpet is simply shredded into fibers, and a portion of the latex and inorganic filler are removed as sand or dust. However, this method has the disadvantage of leaving the backing polypropylene fibers still intermixed with the face fibers. Furthermore, the bottom end of each face fiber retains a significant portion of the latex and inorganic filler, making this face fiber unsuitable for uses that require a more purified recycled face fiber.

U.S. Pat. No. 5,889,142 discloses a process for selectively separating polyamides from multi-component waste materials that includes the steps of subjecting the multi-component mix to a specific mixture of caprolactam and water at a preselected temperature range below the degradation temperature of the polymer to be recovered, separating the formed polyamide solution, and recovering the desired polyamide.

U.S. Pat. No. 7,067,613 discloses, in the recycling of Nylon 6 and Nylon 6,6 polyamides from post-consumer or post-industrial waste, a process to separate the polyamides from commingled polyolefin waste components, particularly polypropylene, by admixing the waste with an ester solvent composition and heating the admixture to a temperature above the melting temperature of the contained polyolefins to form an ester solvent composition further containing dissolved polyamide polymer and a separate immiscible liquid polyolefin phase.

U.S. Pat. No. 6,752,336 discloses a method of recovering carpet materials by reducing carpet into size-reduced fibers, slurrying the size-reduced fibers in a liquid medium, and then selectively separating the size-reduced fibers in a centrifuge. The method is said to be particularly appropriate for recovering nylon or polyester face fibers from post-industrial, pre-consumer carpet waste.

U.S. Pat. No. 6,498,250 discloses a process for nylon depolymerization in which a multi-component material, comprising nylon and one or more non-nylon components, is fed to a depolymerization zone in which depolymerization of at least part of the nylon is effected, resulting in a product stream and a residue, the product stream containing monomers of the nylon, and the residue containing non-nylon components, in which the nylon content in the residue is measured and used to control the depolymerization process.

U.S. Pat. No. 7,784,719 discloses methods of recovering primary construction materials from whole carpet that are said to be particularly appropriate for recovering nylon or polyester face fibers from post-industrial, post-consumer carpet waste. The methods include reducing the whole carpet into fragmented carpet materials (i.e., pile, backing, and binder), further reducing the fragmented carpet materials into size-reduced fibers and binder, slurrying the size-reduced fibers and binder in an aqueous liquid medium (e.g., water), and then separating the size-reduced fibers and binder in a centrifuge.

U.S. Pat. Publn. No. 2011/0040027 discloses a method of recycling carpet components that comprises converting post-consumer carpet that includes a latex backing into a free-flowing powder that is said to be suitable for incorporation into one or more products as a recycled product component. Various processes of converting post-consumer carpet comprising a latex backing are disclosed, including a process in which a portion of face fibers may be harvested from used, post-consumer carpet, or the carpet may simply be shredded to form a first mixture, after which a portion of carpet fibers are separated from and removed from the first mixture to form a second mixture, which may subsequently be exposed to a relatively high level of heat to thermally degrade and/or partially volatilize polymeric material present in the second mixture. This mixture may then be incorporated into new products, either alone or admixed with a solid inorganic particulate material.

U.S. Pat. No. 8,864,057 discloses methods of recovering face fiber from whole carpet by heating the whole carpet to a temperature sufficiently high and a time sufficiently long to thermally decompose at least a portion of the backing material, rendering the backing material friable and to then apply mechanical force to the carpet so as to liberate the face fiber material from the friable backing material. According to an aspect, the backing material, which is typically a woven material, comprises a material that may be thermally decomposed, pyrolyzed, or oxidized, for example a polyolefin such as polyethylene or polypropylene. The backing material may further comprise additional materials such as adhesives and inorganic fillers, which together form a friable backing material or a backing residue when the carpet is heated. While this process is useful for the recovery of face fiber, it does not allow for the recovery of a useful polypropylene stream, since the polypropylene is included in the friable backing material and has been degraded to form a friable material.

Notwithstanding the carpet recycling methods just described, there remains a need in the art for improved processes for recycling carpet, especially those containing face fibers such as nylons and polyesters.

### SUMMARY

Aspects of the present application address the above matters, and others. According to one aspect, a method for recovering face fiber materials and a backing material from a carpet is provided, wherein the carpet has the face fiber materials, the backing material, and an adhesive. The method comprises applying a first mechanical force to the carpet to break a bond between the adhesive and the face fiber materials. The method comprises separating at least 25% of the adhesive from the face fiber materials to form a blend of the face fiber material and the backing material. The method comprises heating the blend of the face fiber material and the backing material to a temperature sufficient to melt the backing material and convert the backing material into backing droplets, the temperature also being less than a melting point of the face fiber materials. The method comprises cooling the face fiber materials to cause the backing droplets to solidify into granules. The method comprises applying a second mechanical force to the face fiber materials to separate the face fiber materials from the granules.

According to another aspect, a method for recovering face fiber materials and a backing material from a carpet having the face fiber materials, the backing material, and an adhesive is provided. The method comprises applying a first mechanical force to the carpet to break a bond between the adhesive and the face fiber materials. The method comprises separating the adhesive from the face fiber materials to form a blend of the face fiber material and the backing material. The method comprises heating the blend of the face fiber material and the backing material to a temperature sufficient to melt the backing material.

According to another aspect, a method for recovering face fiber materials and a backing material from a carpet having the face fiber materials, the backing material, and an adhesive is provided. The method comprises applying a first mechanical force to the carpet to break a bond between the adhesive and the face fiber materials. The method comprises separating at least 25% of the adhesive from the face fiber materials to form a blend of the face fiber material and the backing material. The method comprises heating the blend of the face fiber material and the backing material to a temperature to melt the backing material and convert the backing material into backing droplets, the temperature less than a melting point of the face fiber materials, the face fiber having a higher melting point than the backing. The method comprises cooling the face fiber materials to cause the backing droplets to solidify into granules. The method comprises applying a second mechanical force to the face fiber materials to separate the face fiber materials from the granules.

Those of ordinary skill in the art will appreciate still other aspects of the present application upon reading and understanding the appended description.

### FIGURES

The application is illustrated by way of example and not limitation in the figures of the accompanying drawings, in which like references generally indicate similar elements and in which:

FIG. 1 illustrates an example method for recovering face fiber materials and a backing material (polypropylene) from a carpet having the face fiber materials, the backing material, and an adhesive.

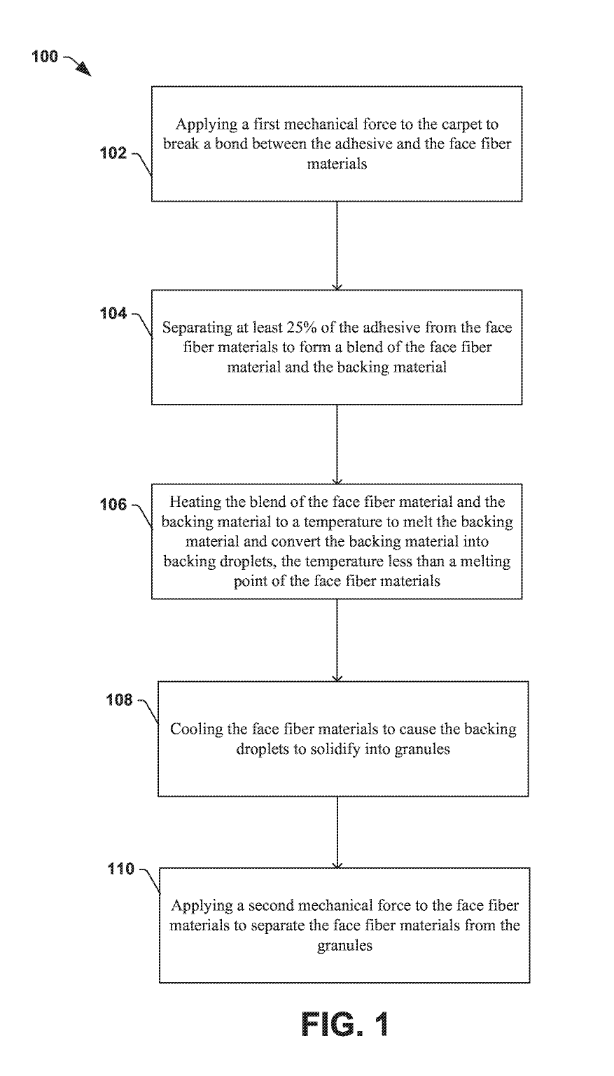

FIG. 2 illustrates an example method for recovering face fiber materials and a backing material (polypropylene) from a carpet having the face fiber materials, the backing material, and an adhesive.

FIG. 3 illustrates an example method for recovering face fiber materials and a backing material (polypropylene) from a carpet having the face fiber materials, the backing material, and an adhesive.

### DESCRIPTION

The claimed subject matter is now described with reference to the drawings, wherein like reference numerals are generally used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are illustrated in block diagram form in order to facilitate describing the claimed subject matter.

In an example, carpet may comprise one or more of face fiber materials, a backing material, an adhesive, and a filler material. In a typical carpet manufacture, lengths of the face fiber may be sewn into the backing material in a process called tufting. In a possible example, the backing material may comprise polypropylene. However, the connection between the backing and the face fiber is sometimes weak, and may not provide a long-lasting floor covering. To address this issue, carpet manufactures may apply a layer of adhesive to bond the face fibers to the backing material. This adhesive may include a latex material, such as styrene butadiene rubber (e.g., SBR), ethylene vinyl acetate (e.g., EVA), etc. emulsified in water. In some examples, to provide more weight to the carpet and a more flat floor covering, this latex can be weighted, such as with an inorganic filler, such as calcium carbonate, limestone, etc. before being applied to the carpet. As a result, a durable floor covering may be provided that has relatively long longevity. In other examples, alternate adhesive systems may comprise polyurethane, various natural and synthetic rubbers, foamed elastomers, blends of the foregoing, etc. can be used as the adhesive.

To recycle carpet, one must overcome the attachment between the fibrous components and the adhesive, and between the face fibers and the backing. As such, three products may be created: (1) a face fiber product; (2) a backing (e.g., polypropylene) product; and (3) an adhesive product. If the materials are not sufficiently separated, then it may not be possible to re-use the polymeric components (e.g., polyamids, polyesters, polypropylene, etc.) in the manufacture of other fibers and articles.

The present application relates to a method 100 for recovering face fiber materials and a backing material from a carpet having the face fiber materials, the backing material, and an adhesive. At 102, the method 100 comprises applying a first mechanical force to the carpet to break a bond between the adhesive and the face fiber materials. For example, the carpet can be mechanically disassembled by mechanically breaking a bond between the adhesive and the fiber. This may be accomplished by using a device that may apply force/impact to the carpet, causing a fracturing of the bond between the adhesive and the face fibers. In a possible example, the device may comprise a hammer mill, in which swinging hammers on a central rotating shaft repeatedly strike pieces of carpet until the pieces of the carpet are small enough to pass through a screen. These repeated strikes can mechanically break the bond between the adhesive and the face fiber. While a hammer mill structure is known and has been used, hammer mills are not known to have been used to separate polypropylene. Likewise, prior hammer mill applications did not include steps related to heating or post-heating cleaning.

The feed to the hammer mill may comprise pieces of appropriate size relative to the size of the holes in the screen. If the pieces are too large, the residence time in the mill may be too long, and the carpet may overheat. In some examples, this heat can cause even the face fiber to melt. If the pieces are too small, the residence time in the mill is too short, and there is insufficient impact to break the bond between the adhesive material and the fibrous material. Proper sizing can be determined by testing. Screen holes sizes between 12 and 48 mm (e.g., approximately 0.5 and 2 inches) are useful.

It will be appreciated that the impact device is not limited to the aforementioned hammer mill, as other impact devices can be used to mechanically break the bond between the adhesive and the fiber. For example, other impact devices may comprise ball mills, rod mills, pin mills, single shaft shredders, dual shaft shredders, quad shaft shredders, granulators, carders, fiber combs, fiber “gins”, autogenic grinding mills, fiber cleaners or any other device or combinations of devices capable of mechanically breaking the bond between the adhesive and the fiber.

One or more impact devices can be used in series to achieve the desire mechanical breaking. These can be the same type of device or different devices. In some examples, an optional cooling step can be employed in between impact devices to prevent the generation of excessively high temperatures in the impact devices.

At 104, after the impact device breaks the bond between the adhesive and the face fibers (e.g., at 102), the adhesive can be separated from the face fibers. Since the adhesive (along with the optional inorganic filler material) is in granular form at this point in the process, the adhesive can be removed by various types of screening devices. In an example, using a screen with openings of about 3 mm to about 12 mm, the majority of the face fibers may be retained on the surface of the screen while the bulk of the granular adhesive and inorganic filler may pass through the screen to the collection device below.

In an example, larger screen opening may lead to better removal of the adhesive, but lower yields of the face fibers. In an example, smaller screen openings may improve face fiber yield, but may retain some of the larger pieces of adhesive.

One or more screening devices can be used in sequence to achieve the proper degree of separation. These can be the same type of device or a different device. The screen sizes can be the same or different. Optionally, in some examples, the material passing through a first screening device can be re-processed through a different separation device to recover lost fiber, thereby improving yield of the face fibers. In an example, the steps of applying the first mechanical force (e.g., at 102) and separating (e.g., at 104) may be performed simultaneously with any number of different structures, such as at least one of a rotary impact separator, a pin roll, etc. By being performed simultaneously, the step of applying the first mechanical force (e.g., at 102) and separating (e.g., at 104) may be carried out in the same apparatus, such as a rotary impact separator, for example. In such an example, the apparatus (e.g., the rotary impact separator) can apply the mechanical force to the material and also separate the material once the mechanical force has been applied.

Alternatively, aspiration devices can be used to separate at least some of the adhesive granules from the fibrous material using vacuum, pressure, and directed streams of air. In an example, one or more of these separation devices can be used in series. These devices can be the same type of devices or different devices.

According to some examples, some impact devices offer the ability to simultaneously break the bond between the adhesive and the face fibers, and separate the adhesive granules from the face fibers. One type of equipment that can achieve this simultaneous mechanical disassembly and adhesive granule separation are fiber cleaning equipment. In this equipment, carpet pieces may be impacted by pins on a rapidly rotating steel roller, breaking the bond between the adhesive and the face fibers. Simultaneously, air streams and inertia separate granular from face fibers. Thus the first two steps of mechanical disassembly and adhesive granule separation can be combined into a single piece of equipment.

In some examples, it may be possible to achieve sufficient mechanical disassembly and adhesive granule separation in a single unit of this type. In other examples, a series of these devices may be used to improve yield and quality. These devices can optionally employ either internal or external recycle of fibers to improve and/or maximize fiber recovery. Equipment of this type can also be combined with the impact and separation equipment described above.

In an example, it may be beneficial to remove an amount of the adhesive material from the fibrous material prior to the next process step to minimize contamination of the face fiber and the backing (e.g., polypropylene) product streams. The separation is may be accomplished when the face fiber and the backing (e.g., polypropylene) are both in fiber form and the adhesive is in granular form. In some examples, at least 25% or, in some examples, at least 50% or, in other examples, at least 75% or, in other examples, at least 90% of adhesive is removed from the face fiber material. In an example, the separation can be accomplished in any number of ways, such as with a vibratory screener, a rotary screener, an aspiration structure, a pneumatic separator, etc.

For the purposes of this disclosure, “fiber” may be defined as having a ratio of the longest dimension of a particle to the shortest dimension of that particle of at least 10 to 1. “Granular” may be defined as having a ratio of the longest dimension of a particle to the shortest dimension of that particle of less than 10 to 1.

At 106, the method 100 comprises heating the blend of the face fiber material and the backing material to a temperature to melt the backing material and convert the backing material into backing droplets, the temperature less than a melting point of the face fiber materials. At 108, the method 100 comprises cooling the face fiber materials to cause the backing droplets to solidify into granules. In this example, the backing (e.g., polypropylene) can be converted into a granule. As the temperature is raised to above the melting point of the backing (e.g., polypropylene), which may be about 130 Celsius, the face fibers may be converted from a solid to a liquid. Surface tension can pull the liquid into a quasi-spherical shaped droplet. The higher the temperature, the lower the polypropylene viscosity, and the faster the face fibers draw themselves into a droplet. After the cooling step, the backing (e.g., polypropylene) droplets become small granules intermixed with the still-fibrous face fibers. In an example, the blend may be heated to a temperature that is at least higher than the melting point of polypropylene and lower than the melting point o the face fiber material. As such, in a possible example, the blend of the face fiber material and the backing material may be heated to a temperature that is between about 130 Celsius to about 265 Celsius.

The heating and cooling of the mixture comprising face fiber and polypropylene in 106 and 108 can be accomplished by a number of means. One method is to randomly lay the fiber into a loose mat or web on a porous belt, and to pass hot gases through the fiber web to raise the polypropylene temperature above its melting point. Subsequently, the polypropylene droplets can be re-solidified into polypropylene granules by passing cold gas through the fiber web. The gases include air, nitrogen, steam, carbon dioxide, and mixtures of the foregoing. The same or different gases can be used for heating and cooling. In an example, the step of heating the blend and the step of cooling the face fiber materials may be carried out in the same apparatus.

Other means of heating such as infrared heating or conductive heating from a hot surface can be used alone or in conjunction with convection means. In an example, a device for the heating and cooling of the fiber for steps 106 and 108 comprises themobonding ovens. These ovens are often used for the production of non-woven sheet goods. Other alternatives may comprise single-layer conveyor ovens, multi-layer conveyor ovens, heated pug mills, externally heated rotary kilns, transfer line reactors and the like. In some examples, the heating and cooling can occur sequentially. However, these two steps can be carried out in the same device or in different devices. In an example, possible heating sources may comprise a thermobond oven, a rotary oven, a heated belt, an infrared heating source, a convective heating source, etc.

In the heating step, it is beneficial to not exceed the melting point of the face fiber. This is so as to maintain the face fiber in a fibrous form while the polypropylene changes into a fluid form. This facilitates the facile removal of polypropylene in a subsequent step after cooling and converting the polypropylene fluid into a granule. In addition, it is also beneficial in the heating step to provide a means of containing the face fiber inside of the heating device, to avoid loss of significant amounts of face fiber with exhaust gas streams. Such devices can include baffles, screens, and cyclones.

At 110, the method 100 comprises applying a second mechanical force to the face fiber materials to separate the face fiber materials from the granules. In this step, the granules (e.g., polypropylene) can be mechanically separated from the face fibers. An impact device such as a hammer mill can be used to shake the polypropylene granules free from the face fibers, and the granules can be removed by a screening means or an aspiration means such as those described above. Alternatively, a fiber cleaning device can be used to open and orient the face fiber, create a web, comb the granules off of the face fiber, and remove them in an air stream. The mechanical force (e.g., the first mechanical force, the second mechanical force, etc.) can be applied in any number of ways, such as with a hammer mill, a rotary impact separator, a pin roll, etc.

In some examples, it may be useful to use a series of impact and/or fiber cleaning devices to further open, clean and align the face fibers for subsequent use. The recovered face fibers are useful for the manufacturing of mats of webs, such as those produced by an air laid or cross-lapping device. Alternatively, the polymer can be extruded into strands or pellets or sheets and used in the manufacture of a wide variety of products. The fiber can also be chopped and injection molded.

In a similar fashion, the recovered polypropylene granules can be use directly in the manufacture of polymeric goods, they can be extruded into pellets for more facile handling, or they can be further purified and used in the manufacture of a wide range of industrial and consumer goods.

As used herein, the term “carpet” is intended to be interpreted broadly to describe a decorative or protective multi-component material that includes a polypropylene backing material, a face fiber material typically comprised of a plurality of fibers made of polyamide or polyester, and an adhesive comprising an organic material and optionally an inorganic filler. In one aspect, the face fiber material may comprise, for example, a nylon or a polyester, the backing material a woven polypropylene, and the adhesive an inorganic filled latex.

The types of carpet useful according to an aspect include new carpet, post-industrial carpet, or post-consumer carpet. As used herein, the term “carpet” also includes the residue from carpet shearing processes, often referred to as “carpet carcass”. This comprises backing material with the residual fiber that remains attached after mechanical shearing. It will be appreciated that the term “carpet,” may be interpreted broadly, and may encompass artificial turf, synthetic grass, etc.

Some types of carpet use a mesh-like polypropylene primary and secondary backing. These are easier to disassemble, and are good feedstock for this disclosure. Some types of carpet include a non-woven polypropylene primary and/or secondary backing. While these types of carpets require more effort to mechanically disassemble, they are quite suitable for this disclosure.

Other types of carpet include a rubber-like backing layer to provide more resilience. These rubber-like backing layers can be made of elastomeric materials comprising a rubber blend, polyurethane, foamed elastomers and the like. Due to the low decomposition temperature of these rubber-like compounds, they would prevent carpet from being recycled according to the process described in U.S. Pat. No. 8,864,057. However, since this layer is removed in the initial mechanical disassembly step of this disclosure, it is still a suitable feedstock for this process.

The face fiber material may comprise, for example, a polyamide or a polyester, or a mixture of polyamides, or a mixture of polyesters, or a mixture of polyamides and polyesters, all of which melt at a temperature higher than the melting temperature of polypropylene.

Nylons may also be known as polyamides, and the terms are used herein interchangeably to describe polymers comprised of repeating units joined by amide groups, including without limitation nylon-6 and nylon-6,6. Polyesters amenable to separation according to the disclosure are polymers having repeating ester linkages and include polyethylene terephthalate (PET) homopolymers and copolymers, polybutylene terephthalate (PBT) homopolymers and copolymers, Polytrimethylene Teraphthalate (PTT) and the like, including those that contain co-monomers such as cyclohexanedimethanol, cyclohexanedicarboxylic acid, and the like.

In carpet, the face fiber material may be oriented with respect to the backing material in a U-shape, in which a fiber is inserted into the backing material and forms a U, with the middle of the fiber in contact with the backing material, and the fiber either cut to a uniform length, called plush pile, or left uncut, so-called loop pile. Piles of either form are described herein as face fibers, and are suitably separated from the backing material by the processes according to the disclosure.

Carpets may thus typically be formed by the face fiber being anchored into a web of backing material, for example polypropylene threads, that are flexible at ambient temperature. Carpets useful for the inventive process will also include an adhesive such as a latex, for example an SBR (styrene/butadiene/rubber) latex or an EVA (ethylene vinyl acetate) latex, with the latex optionally filled with an inorganic substance such as calcium carbonate as an inorganic filler, provided to add weight to the carpet, with the adhesive helping to maintain the face fiber material attached to the backing material. The carpets may further comprise a polypropylene net-like material or a polypropylene non-woven fabric layer in contact with the adhesive material, also intended to ensure that the face fibers do not inadvertently separate from the backing material during use. In addition to or in place of this net-like or non-woven layer, carpet can have a rubber-like layer attached, often make of foamed urethane or other elastomeric materials.

Some carpets can be made with a non-woven face fiber layer attached to a polypropylene backing layer with adhesive. Such carpets may be suitable for recycling in the present disclosure.

Thus, in one aspect, the disclosure relates to processes for recovering both face fiber material and polypropylene backing from a carpet that includes a face fiber material and a backing material, the process comprising: a) applying mechanical force to the carpet to disassemble the carpet and to break the bond between the adhesive and the fiber, b) mechanically separating more than 25% of the adhesive from the fiber, c) heating the resultant blend of face fiber and polypropylene to a temperature sufficiently high to melt the polypropylene, but lower than the melting point of the face fiber, converting the polypropylene fibers into droplets d) cooling the face fiber causing the polypropylene droplets to solidify into granules, and e) applying mechanical force to the face fiber so as to liberate and separate the face fiber material from polypropylene granules.

The application further comprises the face fiber material recovered according to the processes described herein. This face fiber material may be in the form of a fiber, or may be extruded to form an article, or may be injection-molded to form an article.

The application further comprises the polypropylene material recovered according to the process of this disclosure. This polypropylene may be in the form of a granule, or may be extruded or injection molded to form an article. The process may further comprise industrial uses for the adhesive stream comprising an organic and an optional inorganic component obtained from the first step of the process.

In one aspect, the carpet fed to the processes may be provided as pieces of carpet shredded to a size suitable for easy handling. Shredded feed suitable for this process can range in maximum size from as small as 0.5 cm square to as large as 1 meter square. This shredding can occur in any type of commercial shredder or granulator. The optimum size is a function of the specific requirements of the mechanical disassembly device.

According to an aspect of the disclosure, after preparatory shredding, any ferrous contamination may be removed, for example, by magnetic separation. Fines and incidental dirt may likewise be removed, although this too may not be required. Finer shredding, if used, may generate more fines. The shredded carpet may optionally be granulated and screened to obtain a relatively small particle size distribution. However, pieces of carpet at least about 25 square mm and more preferably about 625 square mm, and more preferably 2500 or more square mm appear to be suitable for this process.

An additional benefit of the disclosed method is that it can be practiced at lower temperatures than previous processes, such as that described in U.S. Pat. No. 8,864,057. This results in less thermal damage to face fiber, preserving its chemical and mechanical properties. Furthermore, the polypropylene is only melted. It is not thermally degraded or converted into a friable substance. Thus, it too can be recovered and recycled. Lower temperatures also results in decreased release of malodorous compounds.

Another benefit of the disclosed method is that through the heating portion of the process, many of the pathogenic contaminants found in used carpet are killed. This includes various bacteria, insects, and vermin. Such destruction renders the face fiber from this process much cleaner and more hygienic than that derived by simple shearing.

The time and temperature needed to cause the bulk of the polypropylene fiber to melt and flow into droplets is a function of the temperature of the gases being passed through the face fiber/polypropylene fiber mixture, the ratio of the mass of hot gas to mass of fiber mixture, and the permeability of the fiber. For example, if the heating were to occur in a thermobonding type unit, one could create a very thin and porous mat or web of fiber with excellent permeability that would heat very quickly—perhaps in a matter of seconds. Such a web would require a very low residence time in the hot zone. Alternatively, one could create a much thicker porous mat or web of fiber that may require several minutes to reach a uniform temperature sufficient to melt the polypropylene fibers. Such a web would consequently required longer residence time in the hot zone, and would travel at a slower rate. However, there would be a greater weight of fiber per linear foot of web, since the web has a greater density.

In either case, however, the permeability of the web to hot gases is much greater than the permeability of whole carpet or a pile of shredded carpet pieces. This is because the first step of the process, the mechanical disassembly of the carpet, breaks up the polypropylene backing into its component fibers and removes the adhesive. It is this adhesive coated web of polypropylene that provides the greatest resistance to air flow and permeability, and provides the greatest resistance to heat transfer. Thus, the mechanical disassembly step actually provides two benefits: a) it breaks the bond between the adhesive and the fibrous material, and b) it breaks up the woven or non-woven polypropylene backing into its component fibers, increasing permeability.

The time required for the melting of the polypropylene fibers can also be influenced by using other means of heat transfer either alone or in combination with the methods described above. These would include infrared heating, and conductive heating.

Although it is best in each stage of operation to separate all of a particular component, such a perfect separation is usually not practical nor economical. It is beneficial, therefore, to optimize each separation step depending on the ultimate use of the components and the requirements of the next sequential step in the process. For example, while it would be best to remove all of the adhesive in the first mechanical disassembly step, it is sufficient to remove most of the adhesive. Excellent results can be obtained by remove at least 25% or, in some examples, at least 50%, at least 75% or at least 90% of the adhesive in the feed at this step. In a similar manner, in the separation of polypropylene granules from the face fiber, excellent results can be obtained by removing at least 25% or, in some examples, at least 50% or at least 75% or at least 90% of the polypropylene granules at this step.

The face fibers may thereafter optionally be further washed, cleaned, combed or carded to further reduce attached contaminants using techniques known to those skilled in the art of fiber cleaning. A float/sink separation may optionally be provided to further reduce contaminants, thus capitalizing on the greater specific gravity of the contaminants vs. the specific gravity of the face fiber. Froth flotation may likewise optionally be used to further reduce contaminants, thus capitalizing on the much higher surface-to-volume ratio of the face fibers compared with that of the crushed contaminants. The cleaned fibers may thereafter optionally be formed into granules or pellets either by melting in a unit such as an extruder with an attached pelletizer or a Condux type densifier or by compression in a unit such as a California Pellet Mill (CPM), for easier handling and storage. Alternatively the fibers may be used as is, for example for chemical recycling or extrusion or injection molding.

In a similar fashion, the polypropylene granules may thereafter optionally be further washed, cleaned, aspirated, or screened to further reduce attached contaminants using techniques known to those skilled in the art. A float/sink separation may optionally be provided to further reduce contaminants, thus capitalizing on the greater specific gravity of the adhesive or face fiber relative to the specific gravity of the polypropylene. The cleaned granules may thereafter optionally be formed into pellets either by melting in a unit such as an extruder with an attached pelletizer or a Condux type densifier or by compression in a unit such as a California Pellet Mill (CPM), for easier handling and storage. Alternatively the granules may be used as is, for example for fuel, chemical recycling or extrusion or injection molding.

A variety of heat sources may be used according to the disclosure, including natural convection ovens, forced convection ovens, microwave ovens, infrared ovens, or the like. These heat sources may be used to directly heat the mixture of face and polypropylene fibers (such as in the case of infrared radiation), or can be used to heat a gas stream that is passed through a web or mat or accumulation of mixed fiber. Gases used to transfer heat to the fiber include air, nitrogen, carbon dioxide, steam, and mixtures of these gases with other each other or other gaseous components. Since oxidation of the polypropylene backing is not required in this disclosure, there is no requirement to include oxygen in the mixture. However, since the required temperatures are relatively low, there is minimal oxidation, and air is an acceptable medium for heat transfer.

To further elaborate, in one aspect, the process may be carried out by shredding a part of or even an entire bale of carpet to a size suitable for easy handling. It should be noted that it is not necessary to remove any baling wire prior to the shredding, since any wire pieces may be removed magnetically after shredding. The shredding may be carried out in a variety of manners, for example using a twin-shaft shredder, or a single-shaft shredder or a granulator, or a carding machine or a “cat's claw.” The shred top size may, if desired, be less than one meter square, or less than one decimeter square, or less than 1 centimeter square or less than 0.5 centimeters square.

Any ferrous contamination may be removed, for example, by magnetic separation of nails, staples, other ferrous contaminants, and the like. Non-ferrous metallic contaminants can be removed, for example, by eddy current machines. Fines and incidental dirt and sand may optionally be removed at this point, if desired, using screening, aspiration, or any other suitable means to remove fines from the shredded material.

The shredded carpet may optionally be granulated to an even smaller particle size distribution, for example by a granulator such as those made by Cumberland or Herbold. These granulators contain a screen that limits the size of the largest particles passing through the unit. Such a granulator screen, if used, may have holes, for example, that are less than 50 mm (about 2 inches) in diameter, or less than 25 mm (about 1 inch) in diameter.

It is beneficial to avoid over chopping of the carpet in a manner that substantially reduces the length of the face fibers and polypropylene backing fibers. The separations in this disclosure are based on separating components of different substantially different morphology (i.e. granules from long fibers). If all components are brought to roughly the same size and shape, then such morphological separation becomes more difficult if not impossible.

Since the carpet is disassembled in the first step, there is no issue of orientation of the carpet with respect to the heating elements. The mixed face fiber and polypropylene fiber stream from the second step is isotropic. This is an advantage over other processes that retain the initial post-manufacture orientation of the carpet: i.e. loops of face fiber sewn through a polypropylene backing and coated with an adhesive/inorganic filler mixture. In those cases, there is the potential during the heating process for heat to build up at the junction of the face fiber, polypropylene backing fiber and adhesive due to the extremely close proximity of these three materials in that area, and due to the high local mass density at the junction point. For example, in the process described in U.S. Pat. No. 8,864,057, the potential exists for locally high temperatures to exist at the juncture of the face fiber, the polypropylene backing, and the adhesive, causing the face fiber to weaken and ultimately break at that junction point in the fiber cleaning step. This leads to loss of face fiber as fibers too short to be effectively cleaned in a fiber cleaning line. The isotropic nature of the mixed face fiber and polypropylene fiber stream in the present disclosure, along with the removal of the bulk of the adhesive material before heating, minimizes the generation of hot spots that are potentially damaging to the face fiber.

After the polypropylene fibers are melted and form small droplets, they must be cooled to form solid granules of polypropylene. A variety of types of cooling may be acceptable, whether wet or dry. These would include any of the gases or gas mixtures used in the heating of the fiber mixture, ambient air, humidified air, water mist, or liquid water. Indirect cooling methods such as chilled rollers could also be useful. Heat exchange devices may be utilized to recover waste heat.

After cooling, the polypropylene granules are liberated and separated from the face fiber by any suitable method. For example an impact device such as those described above for 102 could be used to liberate the granules, followed by a screening or aspiration device such as those described above for 104 to separate the loose granules from the face fiber. Another option is the simultaneous liberation and separation of the granules using a fiber cleaning device such as that described above for 102 and 104. Or one could pass the face fiber and polypropylene granules through a series of liberation and separation devices until suitable purity of face fiber was realized.

The clean face fiber may optionally be pelletized for easy handling and storage, via an extrusion and pelletizing operation, for example with a Gala underwater pelletizer, or a strand die and chopper, or compression pelletized for example using a California pellet mill. The face fiber could be agglomerated in a unit such as a Condux agglomerator or a tub densifier. The face fiber could be baled or boxed.

The clean polypropylene granules may optionally be packaged “as is” or pelletized for easy handling and storage, via an extrusion and pelletizing operation, for example with a Gala underwater pelletizer, or compression pelletized for example using a California pellet mill. The polypropylene could be agglomerated in a unit such as a Condux agglomerator or a tub densifier.

As will be readily appreciated from the foregoing, advantages of the disclosure include higher recovery of face fiber compared to shearing; higher quality of face fiber compared to simple shredding; low manpower; higher quality face fiber, and the recovery of a usable polypropylene stream

The granular adhesive material with the optional inorganic filler stream may also find use in a number of applications. Depending on the percentage of inorganic filler used, these granules will have a nominal BTU value of 2,000 to 10,000 BTU per pound. This material can be blended with coal to provide both sulfur capture and heating value. Alternatively, the granular adhesive may utilized as an absorbent for spilled liquids, capable of adsorbing both polar and non-polar liquids. This adhesive can also be re-used as a binder, for example in the production of briquettes, pellets, or durable goods.

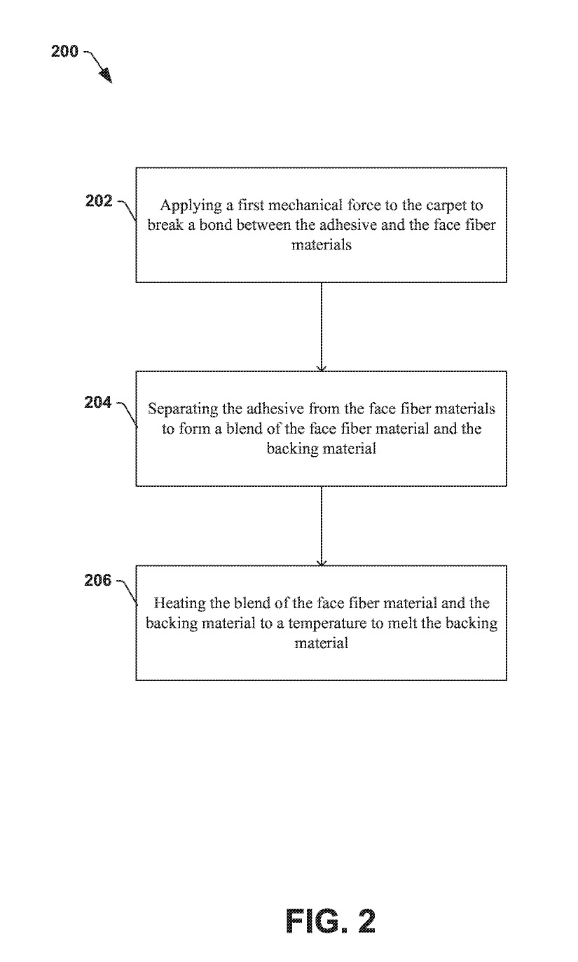

Turning to FIG. 2, a method 200 for recovering face fiber materials and a backing material from a carpet having the face fiber materials, the backing material, and an adhesive is provided. At 202, the method 200 comprises applying a first mechanical force to the carpet to break a bond between the adhesive and the face fiber materials. At 204, the method 200 comprises separating the adhesive from the face fiber materials to form a blend of the face fiber material and the backing material. At 206, the method 200 comprises heating the blend of the face fiber material and the backing material to a temperature to melt the backing material.

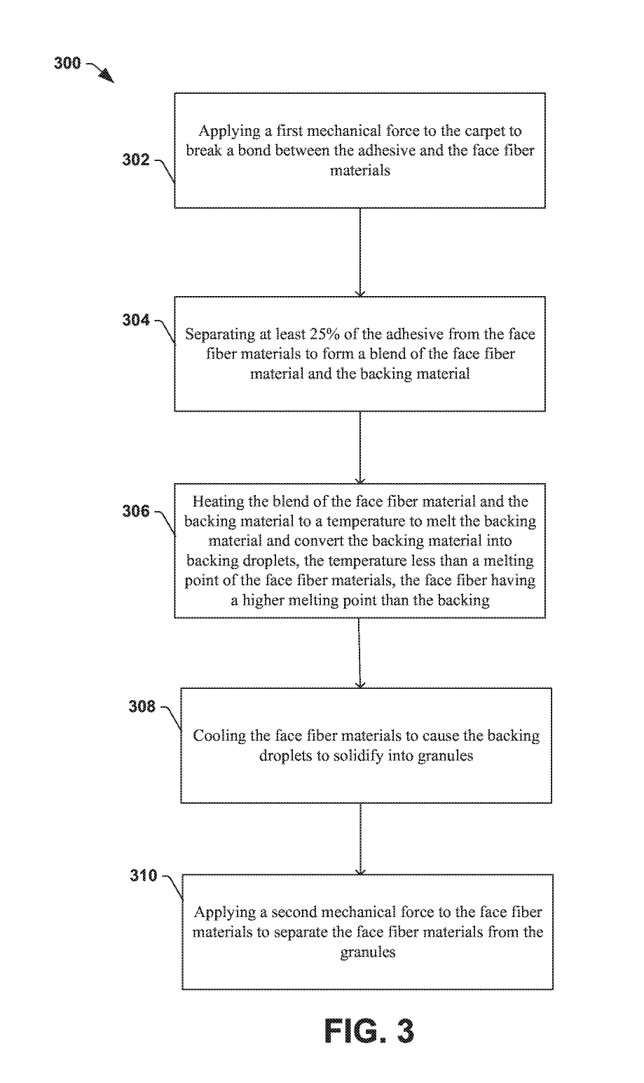

Turning to FIG. 3, a method 300 for recovering face fiber materials and a backing material from a carpet having the face fiber materials, the backing material, and an adhesive is provided. At 302, the method 300 comprises breaking a bond between the adhesive and the face fiber materials and separating a portion of the adhesive from the face fiber materials to form a blend of the face fiber material and the backing material. At 304, the method 300 comprises separating at least 25% of the adhesive from the face fiber materials to form a blend of the face fiber material and the backing material. At 306, the method 300 comprises heating the blend of the face fiber material and the backing material to a temperature to melt the backing material and convert the backing material into backing droplets, the temperature less than a melting point of the face fiber materials, the face fiber having a higher melting point than the backing. At 308, the method 300 comprises cooling the face fiber materials to cause the backing droplets to solidify into granules. At 310, the method 300 comprises applying a second mechanical force to the face fiber materials to separate the face fiber materials from the granules.

It will be appreciated that, in an example, one or more of the aforementioned steps of the methods 100, 200, 300 may be carried out in a continuous process. For example, the steps of applying the first mechanical force, separating at least 25% of the adhesive, heating the blend, cooling the face fiber materials, and applying the second mechanical force may be carried out in a continuous process. By being carried out in a continuous process, the steps may be performed without interruption between steps and the materials in the method may be processed continuously.

In another example, one or more of the steps of the methods 100, 200, 300 may be carried out in a batch-wise fashion. For example, the steps of applying the first mechanical force, separating at least 25% of the adhesive, heating the blend, cooling the face fiber materials, and applying the second mechanical force are carried out in a batch-wise fashion. That is, when processing the materials as batches, the whole of each batch is subjected to one step of the process/method at a time.

### EXAMPLES

### Comparative Example 1

Nylon 66 carpet with a woven polypropylene backing was shredded and sieved to remove granules of adhesive from the product fiber. Total yield of fiber was about 50% of the feed to the process. The composition of the recovered fiber mixture was approximately 75% nylon, 18% polypropylene, and 7% residual adhesive. Such a composition is of low value due to the high levels of polypropylene and adhesive admixed with the nylon.

### Comparative Example 2

Nylon 6 carpet was sheared to remove the face fiber, leaving behind a carcass that comprised the backing and a portion of the face fiber. The yield of face fiber was about 23 wt % of the feed to the process, and the face fiber contained about 2 wt % ash. Such low yields are currently economically unattractive.

### Comparative Example 3

A sample of Nylon 66 carpet with a woven polypropylene backing was passed through a convection oven held at 210 degree C. (410 degree F.) with a total residence time of 10 minutes to partially decompose the carpet backing and to render the backing friable. The oven product was then hammer milled to liberate the friable backing residue from the face fiber. Face fiber was separated from the bulk of the backing residue by screening. The fiber was then further cleaned by carding. The yield of face fiber was about 43 wt %, and the fiber was analyzed at 98% nylon. It was not possible to recover a polypropylene stream. The polypropylene was oxidized and lost in the friable backing stream.

### Comparative Example 4

A sample of Nylon 66 carpet with a soft rubber-like backing was passed through a convection oven held at 210 degree C. (410 degree F.) with a total residence time of 5 minutes. The rubber-like backing material formed malodorous sticky decomposition product that was not friable. An attempt was made to repeat the test at a total residence time of 10 minutes. The test was aborted at approximately 7 minutes when the sample ignited. No further processing of either sample was possible. No face fiber and no polypropylene were able to be recovered.

### Comparative Example 5

A sample of Nylon 6 carpet with a non-woven felt-like polypropylene secondary backing was passed through a convection oven held at 210 degree C. (410 degree F.) with a total residence time of 5 minutes. The polypropylene secondary backing melted, but did not form a friable material. Rather, after cooling, it formed a tough scab on the back of the carpet piece that resisted fracture. It was not possible to recover clean polypropylene-free face fiber from this test.

### Example 1

A sample of cut-pile type carpet with Nylon 66 face fiber and a woven polypropylene backing was subjected to the following steps:

1. Shredded in an SSI shredder with 50 mm (about 2″) blades and shredded in another SSI shredder with 25 mm (about 1″) blades.

2. Hammer milled in a Schutte Buffalo hammer mill with a 25 mm (about 1 inch) screen and re-hammer milled in a Schutte Buffalo hammer mill with a 25 mm (about 1 inch) screen

3. Screened in a Scotts turbo sifter with about 9 mm (⅜ inch) holes to remove the bulk of the adhesive from the mixture of nylon and polypropylene fibers. Approximately 80% of the adhesive and inorganic filler was removed in this step.

4. The resultant Nylon 66 and polypropylene fiber mixture was heated to 170 C for 5 minutes to cause the polypropylene fibers to melt and form small droplets. Heating was accomplished using a porous conveyor belt passing through a gas-fired forced convection oven.

5. The hot mixture of Nylon 66 fibers and polypropylene granules was cooled with a water spray.

6. The cooled fiber mixture was subject to 4 stages of fiber cleaning in a Laroche fiber cleaner to remove the polypropylene granules from the face fiber. Analytical tests showed less than 1 wt % residual polypropylene admixed with the product Nylon 66 face fiber. The yield of face fiber was greater than 90% of the face fiber in the feed.

7. A polypropylene granule stream was also recovered

### Example 2

A sample of continuous loop type carpet with Nylon 6 face fiber and a woven polypropylene backing was subjected to the following steps:

1. Shredded in an SSI shredder with 50 mm (about 2 inch) blades and shredded in an SSI shredder with 25 mm (about 1 inch) blades, and re-shredded in an SSI shredder with 25 mm (about 1 inch) blades. The additional shredding step minimized long strings of face fiber yarn, and prevented fouling of down-stream equipment.

2. Hammer milled in a Schutte Buffalo hammer mill with a 25 mm (about 1 inch) screen and re-hammer milled in a Schutte Buffalo hammer mill with a 25 mm (about 1 inch) screen

3. Screened in a Scotts turbo sifter with about 9 mm (⅜ inch) holes to remove the bulk of the adhesive. Approximately 82% of the adhesive and inorganic filler was removed from the mixture of nylon and polypropylene fibers in this step.

4. The resultant Nylon 6 and polypropylene fiber mixture was heated to 170 C for 5 minutes to cause the polypropylene fibers to melt and form small droplets. Heating was accomplished using a porous conveyor belt passing through a gas-fired forced convection oven.

5. The hot mixture of Nylon 6 fibers and polypropylene granules was cooled with a water spray.

6. The cooled fiber mixture was subject to 4 stages of fiber cleaning in a Laroche fiber cleaner to remove the polypropylene granules from the face fiber. Analytical tests showed less than 1 wt % residual polypropylene admixed with the product Nylon 6 face fiber. The yield of face fiber was greater than 90% of the face fiber in the feed.

7. A polypropylene granule stream was also recovered.

### Example 3

A sample of cut-pile type carpet with PET face fiber and a woven polypropylene backing was subjected to the following steps:

1. Shredded in an SSI shredder with 50 mm (about 2 inch) blades and shredded in an SSI shredder with 25 mm (about 1 inch) blades.

2. Hammer milled in a Schutte Buffalo hammer mill with a 25 mm (about 1 inch) screen and re-hammer milled in a Schutte Buffalo hammer mill with a 25 mm (about 1 inch) screen

3. Screened in a Scotts turbo sifter with about 9 mm (⅜ inch) holes to remove the bulk of the adhesive. Approximately 86% of the adhesive and inorganic filler was removed from the mixture of PET and polypropylene fibers in this step.

4. The resultant PET and polypropylene fiber mixture was heated to 170 C for 5 minutes to cause the polypropylene fibers to melt and form small droplets. Heating was accomplished using a porous conveyor belt passing through a gas-fired forced convection oven.

5. The hot mixture of PET fibers and polypropylene granules was cooled with a water spray and a fan blowing ambient air.

6. The cooled fiber mixture was subject to 4 stages of fiber cleaning in a Laroche fiber cleaner to remove the polypropylene granules from the face fiber. Analytical tests showed less than 1 wt % residual polypropylene admixed with the product PET face fiber. The yield of face fiber was greater than 90% of the face fiber in the feed.

7. A polypropylene granule stream was also recovered

### Example 4

A sample of cut-pile type carpet with Nylon 66 face fiber and a woven polypropylene backing was subjected to the following steps:

1. Shredded in an SSI shredder with 50 mm (about 2 inch) blades and shredded in an SSI shredder with 25 mm (about 1 inch) blades.

2 Hammer milled in a Schutte Buffalo hammer mill with a 25 mm (about 1 inch) screen and re-hammer milled in a Schutte Buffalo hammer mill with a 25 mm (about 1 inch) screen

3. Screened in a Scotts turbo sifter with about 9 mm (⅜ inch) holes to remove the bulk of the adhesive. More than 80% of the adhesive and inorganic filler was removed from the mixture of nylon and polypropylene fibers in this step.

4. The resultant Nylon 66 and polypropylene fiber mixture was heated to 170 C for 5 minutes to cause the polypropylene fibers to melt and form small droplets. Heating was accomplished using a porous conveyor belt passing through a gas-fired forced convection oven.

5. The hot mixture of Nylon 66 fibers and polypropylene granules was cooled with a water spray.

6. The cooled fiber mixture was hammer milled in a Schutte Buffalo hammer mill with a 25 mm (about 1 inch) screen and screened in a Scotts Turbo Separator with about 9 mm (⅜″) holes to remove a portion of the polypropylene granules. Approximately 66% of the polypropylene in the feed was recovered in this step.

7. The fiber mixture was subject to 4 stages of fiber cleaning in a Laroche fiber cleaner to remove and recover the residual polypropylene granules from the face fiber. Analytical tests showed less than 1 wt % residual polypropylene admixed with the product Nylon 66 face fiber. The yield of face fiber was greater than 90% of the face fiber in the feed.

8. A polypropylene granule stream was also recovered

### Example 5

A sample of cut-pile type carpet with Nylon 66 face fiber and a non-woven polypropylene backing sheet was subjected to the following steps:

1. Shredded in an SSI shredder with 50 mm (about 2 inches) blades and shredded in an SSI shredder with 25 mm (about 1 inch) blades.

2 Hammer milled in a Schutte Buffalo hammer mill with a 25 mm (about 1 inch) screen and re-hammer milled in a Schutte Buffalo hammer mill with a 25 mm (about 1 inch) screen

3. Screened in a Scotts turbo sifter with about 9 mm (⅜ inch) holes to remove the bulk of the adhesive. More than 84% of the adhesive and inorganic filler was removed from the mixture of nylon and polypropylene fiber in this step.

4. The resultant Nylon 66 and polypropylene fiber mixture was heated to 170 C for 5 minutes to cause the polypropylene fibers to melt and form small droplets. Heating was accomplished in an electrically heated convection oven.

5. The hot mixture of Nylon 66 fibers and polypropylene granules was air cooled.

6. The cooled fiber mixture was hammer milled in a Schutte Buffalo hammer mill with a 25 mm (about 1 inch) screen and screened in a Scotts Turbo Separator with a 9 mm (⅜″) screen to remove a portion of the polypropylene granules. Approximately 78% of the polypropylene in the feed was recovered in this step.

7. The fiber mixture was subject to 4 stages of fiber cleaning in a Laroche fiber cleaner to remove the residual polypropylene granules from the face fiber. Analytical tests showed less than 1 wt % residual polypropylene was admixed with the product Nylon 66 face fiber. The yield of face fiber was greater than 90% of the face fiber in the feed.

8. A polypropylene granule stream was also recovered

### Example 6

A sample of cut-pile type carpet with Nylon 66 face fiber and a soft rubber-like adhesive and backing was subjected to the following steps:

1. Shredded in an SSI shredder with 50 mm (about 2 inches) blades and shredded in an SSI shredder with 25 mm (about 1 inch) blades.

2 Hammer milled in a Schutte Buffalo hammer mill with a 25 mm (about 1 inch) screen and re-hammer milled in a Schutte Buffalo hammer mill with a 12.5 mm (about 0.5 inch) screen

3. Screened in a Scotts turbo sifter with about 9 mm (⅜ inch) holes to remove the bulk of the adhesive and rubber-like layer. More than 75% of the rubber-like adhesive, backing, and inorganic filler was removed in this step.

4. Fiber passed through a carding machine to remove most of the residual rubber granules

5. The resultant Nylon 66 and polypropylene fiber mixture was heated to 170 C for 5 minutes to cause the polypropylene fibers to melt and form small droplets. Heating was accomplished using a porous conveyor belt passing through a gas-fired forced convection oven.

6. The hot mixture of Nylon 66 fibers and polypropylene granules was cooled with a water spray.

7. The cooled fiber mixture was hammer milled in a Schutte Buffalo hammer mill with a 25 mm (about 1 inch) screen and screened in a Scotts Turbo Separator with a 9 mm (⅜″) screen to remove a portion of the polypropylene granules. Approximately 61% of the polypropylene in the feed was recovered in this step.

8. The fiber mixture was subject to 4 stages of fiber cleaning in a Laroche fiber cleaner to remove the polypropylene granules from the face fiber. Analytical tests showed less than 1 wt % residual polypropylene admixed with the product Nylon 66 face fiber. The yield of face fiber was greater than 90% of the face fiber in the feed.

9. A polypropylene granule stream was also recovered

### Example 7

A sample of carpet tile with Nylon 66 face fiber, a polypropylene backing, and a soft urethane cushion layer was subjected to the following steps:

1. Cut into pieces less than 50 mm (about 2 inches) long

2 Hammer milled in a Schutte Buffalo hammer mill with a 25 mm (about 1 inch) screen and re-hammer milled in a Schutte Buffalo hammer mill with a 12.5 mm (about 0.5 inch) screen

3. Screened in a Scotts turbo sifter with about 9 mm (⅜ inch) holes to remove the bulk of the adhesive and rubber-like layer. More than 65% of the rubber-like adhesive, backing, and inorganic filler was removed in this step.

4. Fiber was passed through a carding machine to remove most of the residual rubber granules

5. The resultant Nylon 66 and polypropylene fiber mixture was heated to 170 C for 6 minutes to cause the polypropylene fibers to melt and form small droplets. Heating was accomplished using an electrically heated convection oven.

6. The hot mixture of Nylon 66 fibers and polypropylene granules was cooled with humidified air.

7. The cooled fiber mixture was subject to 4 stages of fiber cleaning in a Trutzler fiber cleaner to remove the polypropylene granules from the face fiber. Analytical tests showed less than 1 wt % residual polypropylene admixed with the product Nylon 66 face fiber. The yield of face fiber was greater than 90% of the face fiber in the feed.

8. A polypropylene granule stream was also recovered

As used in this application, the terms “component”, “module,” “system”, “interface”, and the like are generally intended to refer to a computer-related entity, either hardware, a combination of hardware and software, software, or software in execution. For example, a component includes a process running on a processor, a processor, an object, an executable, a thread of execution, a program, or a computer. By way of illustration, both an application running on a controller and the controller can be a component. One or more components residing within a process or thread of execution and a component may be localized on one computer or distributed between two or more computers.

Moreover, “exemplary” is used herein to mean serving as an example, instance, illustration, etc., and not necessarily as advantageous. As used in this application, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B and/or both A and B. Furthermore, to the extent that “includes”, “having”, “has”, “with”, or variants thereof are used, such terms are intended to be inclusive in a manner similar to the term “comprising”.

Many modifications may be made to the instant disclosure without departing from the scope or spirit of the claimed subject matter. Unless specified otherwise, “first,” “second,” or the like are not intended to imply a temporal aspect, a spatial aspect, an ordering, etc. Rather, such terms are merely used as identifiers, names, etc. for features, elements, items, etc. For example, a first set of information and a second set of information generally correspond to set of information A and set of information B or two different or two identical sets of information or the same set of information.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A method for recovering at least one of face fiber materials or a backing material (polypropylene) from a carpet having the face fiber materials, the backing material, and an adhesive, the method comprising:
applying a first mechanical force to the carpet to break a bond between the adhesive and the face fiber materials;
separating at least 25% of the adhesive from the face fiber materials to form a blend of the face fiber material and the backing material;
heating the blend of the face fiber material and the backing material to a temperature to melt the backing material and convert the backing material into backing droplets, the temperature less than a melting point of the face fiber materials;
cooling the face fiber materials to cause the backing droplets to solidify into granules; and
applying a second mechanical force to the face fiber materials to separate the face fiber materials from the granules.

2. The method of claim 1, wherein the step of heating comprises heating the blend of the face fiber material and the backing material to a temperature that is between about 130 Celsius to about 265 Celsius.

3. The method of claim 1, wherein the step of applying the first mechanical force and the step of separating at least 25% of the adhesive from the face fiber materials are carried out in the same apparatus.

4. The method of claim 1, wherein the step of applying the first mechanical force and the step of separating at least 25% of the adhesive from the face fiber materials are carried out sequentially.

5. The method of claim 1, wherein the step of heating the blend and the step of cooling the face fiber materials are carried out in the same apparatus.

6. The method of claim 1, wherein the steps of applying the first mechanical force, separating at least 25% of the adhesive, heating the blend, cooling the face fiber materials, and applying the second mechanical force are carried out in a continuous process.

7. The method of claim 1, wherein one or more of the steps of applying the first mechanical force, separating at least 25% of the adhesive, heating the blend, cooling the face fiber materials, and applying the second mechanical force are carried out in a batch-wise fashion.

8. The method of claim 1, wherein the face fiber material comprises a polyester.

9. The method of claim 1, wherein the face fiber material comprises a polyamide.

10. The method of claim 1, wherein the backing material comprises polypropylene.

11. A method for recovering at least one of face fiber materials or a backing material from a carpet having the face fiber materials, the backing material, and an adhesive, the method comprising:
applying a first mechanical force to the carpet to break a bond between the adhesive and the face fiber materials;
separating the adhesive from the face fiber materials to form a blend of the face fiber material and the backing material; and then
heating the blend of the face fiber material and the backing material to a temperature to melt the backing material.

12. The method of claim 11, wherein the backing material comprises polypropylene.

13. A method for recovering at least one of face fiber materials or a backing material from a carpet having the face fiber materials, the backing material, and an adhesive, the method comprising:
applying a first mechanical force to the carpet to break a bond between the adhesive and the face fiber materials;
separating at least 25% of the adhesive from the face fiber materials to form a blend of the face fiber material and the backing material;
heating the blend of the face fiber material and the backing material to a temperature to melt the backing material and convert the backing material into backing droplets, the temperature less than a melting point of the face fiber materials, the face fiber materials having a higher melting point than the backing;
cooling the face fiber materials to cause the backing droplets to solidify into granules; and
applying a second mechanical force to the face fiber materials to separate the face fiber materials from the granules.

14. The method of claim 13, wherein the heating comprises heating with at least one of a thermobond oven, rotary oven, heated belt, infrared heating source, or convective heating source.

15. The method of claim 13, wherein the first mechanical force is applied by at least one of a hammer mill, rotary impact separator, or pin roll.

16. The method of claim 13, wherein the separating is separated by a vibratory screener, rotary screener, aspiration structure, or pneumatic separator.

17. The method of claim 13, wherein the steps of applying the first mechanical force and separating are performed simultaneously with at least one of a rotary impact separator or pin roll.

18. The method of claim 13, wherein the second mechanical force is applied by at least one of a hammer mill, rotary impact separator, or pin roll.
